(19) United States
(12) Patent Application Publication
(10) Pub. No.: US 2022/0067359 A1
(43) Pub. Date: Mar. 3, 2022

(54) PORTABLE DIGITIZATION ACCESSORIES

(71) Applicant: Hewlett-Packard Development Company, L.P., Spring, TX (US)

(72) Inventor: Sook Min Park, Palo Alto, CA (US)

(73) Assignee: Hewlett-Packard Development Company, L.P., Spring, TX (US)

(21) Appl. No.: 17/419,411

(22) PCT Filed: May 20, 2019
(86) PCT No.: PCT/US2019/033126

§ 371 Date: Jun. 29, 2021

(51) Int. Cl. G06K 9/00; H04N 5/232; H04N 5/225; G06K 9/24

(52) U.S. Cl. CPC G06K 9/00402; H04N 5/23299; G06K 2209/01; G06K 9/24; H04N 5/2253

(57) ABSTRACT

An example of an apparatus is provided. The apparatus includes a mounting mechanism to engage with a writing surface. The apparatus also includes a camera connected to the mounting mechanism. The camera is to scan the writing surface. In addition, the apparatus includes an optical character recognition engine to generate content via the digitization of markings on the writing surface. The apparatus includes a communications interface in communication with the optical character recognition engine to transmit the content to an external device.

### BACKGROUND

Printed documents are often used to present information. In particular, printed documents continue to be used despite the availability of electronic alternatives as they are more easily handled and read by users. Accordingly, the generation of printed documents continues to be used for the presentation and handling of information. Similarly, the conversion of printed documents from a physical hardcopy form to a digital form is also used for storage and transmission of information.

### BRIEF DESCRIPTION OF THE DRAWINGS

Reference will now be made, by way of example only, to the accompanying drawings in which:

FIG. 1 is a perspective view of an example apparatus to convert physical documents with markings into an electronic document;

FIG. 2 is a schematic representation of the electronic components of the apparatus of FIG. 1;

FIG. 3 is a perspective view of another example apparatus to convert physical documents with markings into an electronic document without a communications interface;

FIG. 4 is a side view of another example apparatus to convert physical documents with markings into an electronic document without a communications interface with a hinged arm;

FIG. 5 is a schematic representation of the electronic components of the apparatus of FIG. 4; and

FIG. 6 is a flowchart of an example of a method of converting physical documents with markings into an electronic document.

### DETAILED DESCRIPTION

As used herein, any usage of terms that suggest an absolute orientation (e.g. “top”, “bottom”, “vertical”, “horizontal”, etc.) are for illustrative convenience and refer to the orientation shown in a particular figure. However, such terms are not to be construed in a limiting sense as it is contemplated that various components will, in practice, be utilized in orientations that are the same as, or different than those described or shown.

Physical documents may be widely accepted and may often be more convenient to use compared to electronically stored versions of such documents. In particular, physical documents are easy to distribute, store, and be used as a medium for disseminating information. In addition, physical documents may serve as contingency for electronically stored documents, such as may happen when an electronic device fails, such as with a poor data connection for downloading the document and/or a depleted power source.

In further examples, physical documents may be used due to other factors such as regulations, policies, or laws. For example, some industries require physical documents to form physical records to comply with privacy and auditing rules. Despite the use of physical documents as the official record, these same industries generally allow for the use of electronic data records to provide a portable solution that is easily searchable. For example, doctors in some jurisdictions or offices may be asked to maintain physical documents for each patient. The physical documents may be part of a patient's medical chart on which the doctor may use handwritten notes. Accordingly, if the same doctor were to manually convert the notes into electronic medical records the doctor may spend a significant amount of time doing so. Thus, in some situations it may be desirable to have an apparatus to digitize physical documents that is portable and lightweight that may be used on multiple writing surfaces. In particular, an apparatus to digitize physical documents that may be attached and re-attached to lightweight writing surfaces such as a clipboard or notebook to obtain steady scans of the writing may be used instead of larger scanning devices, such as a desktop scanner.

An apparatus to convert physical documents to electronic documents is provided. The apparatus is to be mounted onto a writing surface supporting the physical document, such as a clipboard or notebook such that the camera or scanner is rigidly fixed relative to the writing surface. Accordingly, the apparatus is to scan and process writing on the physical document and to store the information in an electronic document. In one example, the apparatus is to have a small form factor, and be lightweight such that it may be mounted onto a writing surface without significantly affecting the ability to carry around a portable writing surface and thus providing portable digitization of physical documents.

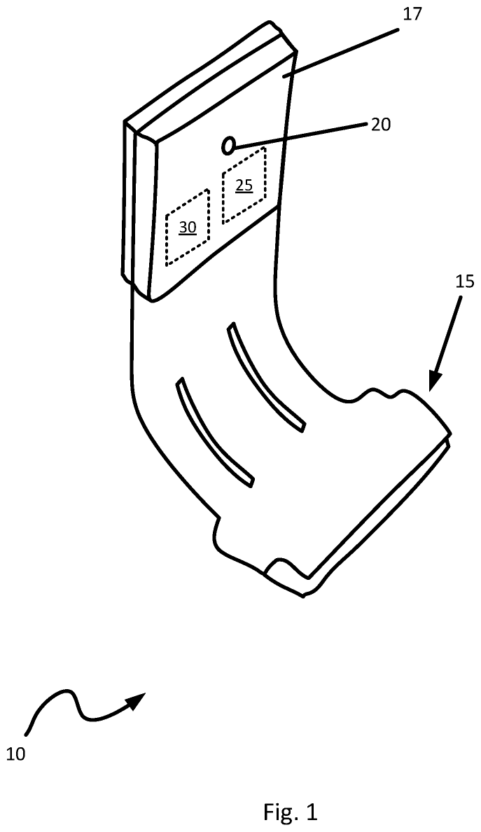

Referring to FIG. 1, an apparatus 10 to convert physical documents with markings into an electronic document is illustrated. The apparatus 10 may be compact and have a bendable arm to further reduce its size for storage purposes. In this example, the apparatus 10 may be mounted to a writing surface (not shown). For example, the writing surface may be a rigid board or other support structure to support media, such as a piece of paper. In particular, the writing surface may be a clipboard. The apparatus 10 may include additional components, such as various additional interfaces and/or connectors to mate with an external device, such as a laptop, smartphone, and/or tablet. In the specific example, the apparatus 10 is to scan a writing surface and to provide electronic data to the external device. In the present example, the apparatus 10 includes a mounting mechanism 15, a camera 20, an optical character recognition engine 25, and a communications interface 30.

The mounting mechanism 15 is to engage with the writing surface. In the present example, the mounting mechanism 15 is to secure the apparatus 10 to the writing surface. In particular, the mounting mechanism 15 is to rigidly attach to a portion of the writing surface. The manner by which the mounting mechanism 15 engages the writing surface is not particularly limited. In the present example, the mounting mechanism 15 is a clip to clamp onto an edge of the writing surface. The clip may be spring loaded to apply pressure to the writing surface. Alternatively, the clip may include a pliable material, such as plastic that may be deformed to fit over an edge of the writing surface. In other examples, the mounting mechanism 15 may engage with a complimentary mating mechanism on the writing surface, such as using a magnetic mounting location. Other mechanisms such as a hook-and-pile, friction fit, screws, bolts and others are also contemplated.

In the present example, the mounting mechanism 15 is disposed at an end of apparatus at a fixed distance from the camera 20 and other components. It is to be appreciated that the mounting mechanism 15 may be varied such that the mounting mechanism 15 engages with the writing surface at a location closer to the camera 20. In other examples, the position of the mounting mechanism 15 along the arm of the device may be adjustable. It is to be appreciated that the arm supporting the device is not particularly limited. For example, the arm may have any shape or composition. For example, the arm may be a bar, a post, or a flat elongated member. The arm may also be bendable, rigid, or a combination of the two, such as having portions that may bend.

The camera 20 is connected to the mounting mechanism 15. In the present example, the camera 20 is to scan the writing surface to which the mounting mechanism 15 is engaged. Accordingly, the camera 20 may scan the writing surface to collect image data from a physical document thereon for the subsequent processing.

The optical character recognition engine 25 is to generate electronic content. In the present example, the optical character recognition engine 25 may generate content from the physical document on the writing surface by digitizing markings present on the surface. Accordingly, the optical character recognition engine 25 may be used to analyze image data captured by the camera 20. The manner by which the optical character recognition engine 25 generates the electronic content is not particularly limited. For example, the optical character recognition engine 25 may use an image correlation technique where glyphs are isolated in the image data captured by the camera 20.

In other examples, the optical character recognition engine 25 may use artificial intelligence techniques to analyze features in the image data captured by the camera 20 to identify features which may be letters or words. By using artificial intelligence techniques, more types of characters may be recognized by the optical character recognition engine 25 such as cursive handwriting as well as various symbols or words in other languages.

In the present example, the camera 20 and the optical character recognition engine 25 may be operating in real time. Therefore, the apparatus 10 may be used on a physical document such as a piece of paper where a user may be adding content, such as handwriting. In particular, the apparatus 10 may be used on a notebook or on a clipboard to generate electronic content in real time as the user adds content to the physical document. For example, if the physical document is a form, such as a medical chart, an application form at a financial services provider, or a survey form, the apparatus 10 may be used to read real time information entered by the user to generate electronic records by populating fields on the form.

The communications interface 30 is to communicate with an external device, such as a laptop, smartphone, tablet, etc. In particular, the communications interface is to transmit the electronic content generated by the optical character recognition engine 25 to the external device. The manner by which the communications interface 30 transmits the data is not particularly limited. For example, the communications interface 30 may transmit the content over a wireless network such as WiFi or Bluetooth. In some examples, the apparatus 10 may be connected to a cloud server to manage the electronic content for distribution to a plurality of client devices, which in turn may be used for the purposes of collaboration among multiple parties. In other examples, the communications interface 30 may provide a wired connection, such as via a universal serial bus (USB), to the external device to avoid wireless and/or unsecure transmission of sensitive information where privacy and security may be an issue.

The manner by which the communications interface 30 receives the content and subsequently transmits the content to the external device is not particularly limited. In the present example, the apparatus 10 may be managed by a central server located at a remote location and the apparatus 10 may be one of many apparatuses broadly distributed over a large geographic area. Such an example may be particularly suitable for collaboration of multiple parties, such as researchers, who may want to generate content to be shared. Accordingly, the apparatus 10 provides the ability to quickly and easily share notes without manually scanning the physical documents and subsequently transmitting via email.

In particular, the use of artificial intelligence by the optical character recognition engine 25 may be suitable to analyze handwritten notes on a clipboard, such as for a medical chart as a doctor carries out rounds in a hospital. The portable nature of the apparatus 10 may allow the doctor to move the apparatus 10 from one clipboard to the next as the doctor moves from one patient to the next. In some examples, each physical document may also include an identifier, such as a unique set of characters or a barcode, to identify the physical document on which the user is writing.

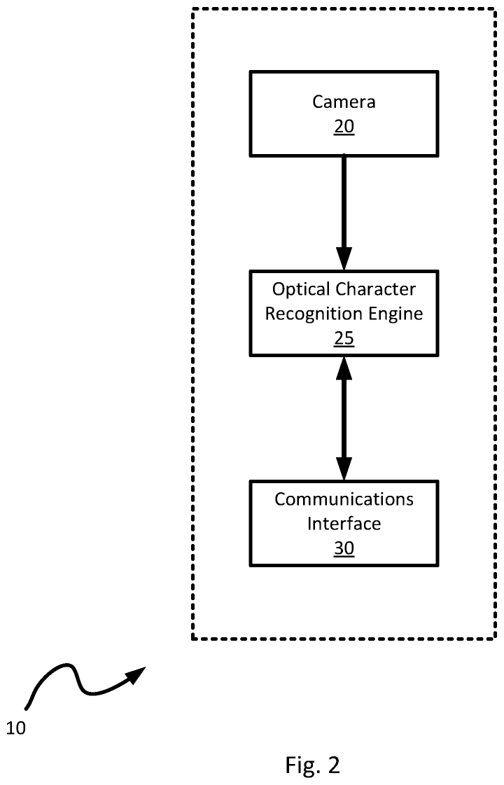

Referring to FIG. 2, a schematic representation of the electronic components of the apparatus 10 is generally shown. In the present example, the camera 20, the optical character recognition engine 25, and the communications interface 30 may be placed in a housing 17 to protect the components. In the present example, the camera 20 is to capture image data of the writing surface to which the apparatus 10 is attached. In particular, the camera 20 is to capture image data from the writing surface in real time and provide the image data to the optical character recognition engine for processing. Accordingly, as the apparatus 10 is attached to the writing surface and turned on, the camera 20 captures the initial physical document on the writing surface. The camera 20 may subsequently capture updated image data in real time. The manner by which the camera 20 captures real time image data is not particularly limited. For example, the camera 20 may periodically take image data after a fixed period of time such as after about each second(s), about every 0.50 s, about every 0.25 s, or about every 0.10 s. It is to be appreciated that the period is not limited and may be increased to reduce the use of computational resources, or decreased to approach or obtain a continuous video feed.

In some examples, the camera 20 may include additional sensor and optical components (not shown) to measure image data over a wide variety of lighting conditions. In some examples, the apparatus 10 may be equipped with multiple cameras where each camera 20 may be designed to cover different fields of view of the writing surface or to cover different operating conditions, such as varying lighting.

The optical character recognition engine 25 receives the image data from the camera 20 in the present example to process and generate content. The exact manner by which the optical character recognition engine 25 processes the image data is not limited. In the present example, the optical character recognition engine 25 may also receive data messages containing data or commands to control how the optical character recognition engine 25 is to operate. For example, optical character recognition engine 25 may receive commands to select a database from which stored glyphs are to be used in a pattern recognition process. The commands may also be used to select a region of the physical document to process.

In other examples, the optical character recognition engine 25 may pre-process the image data and send the pre-processed image data to an external server where the optical character recognition is to occur. It is to be appreciated that optical character recognition, either via pattern recognition or artificial intelligence, may require significant computer resources. Accordingly, it may not be commercially viable to place the computational resources for carrying out a complete optical character recognition within the housing 17. Instead, the optical character recognition engine 25 may pre-process the image data using relatively light resources before the pre-process image data is to be sent to an external server for optical character recognition. In this example, the amount of pre-processing carried out by optical character recognition engine 25 is not limited and may include de-skewing the image data, removing artifacts such as lines and dots, identifying characters and words, and isolating characters and words.

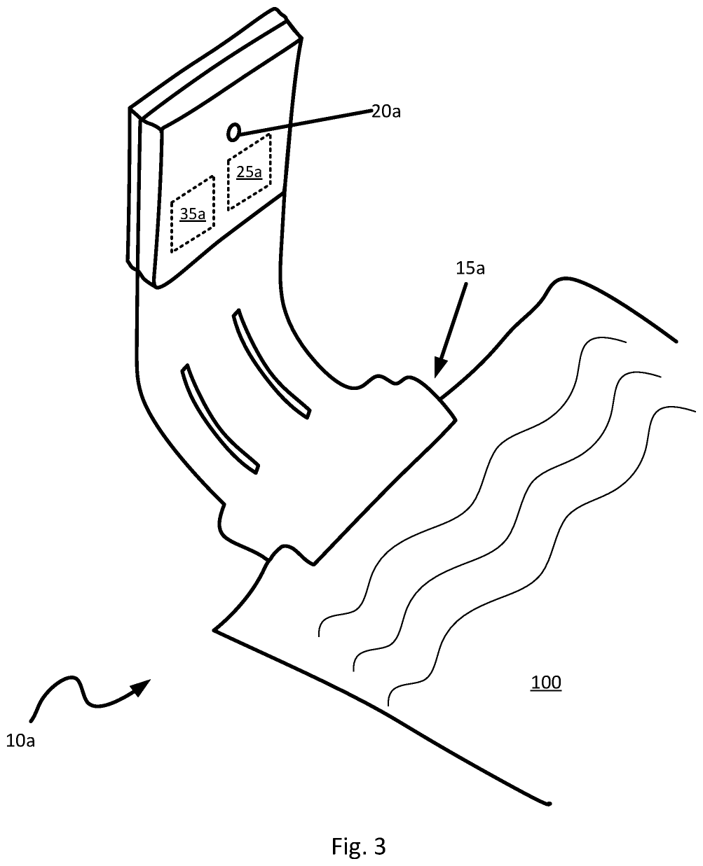

Referring to FIG. 3, another example of an apparatus 10a to convert physical documents with markings into an electronic document is illustrated. Like components of the apparatus 10a bear like reference to their counterparts in the apparatus 10, except followed by the suffix “a.” In this example, the apparatus 10a is mounted to a writing surface 100, which may be a clipboard with paper for taking notes. The apparatus 10a is to scan the writing surface 100 and to provide electronic data to a portable electronic device, such as a smartphone, tablet, or laptop via a physical medium. In the present example, the apparatus 10a includes a mounting mechanism 15a, a scanner 20a, an optical character recognition engine 25a, and a memory storage unit 35a.

In the present example, the scanner 20a is connected to the mounting mechanism 15a. The scanner 20a is to collect image data of the writing surface. The scanner 20a may be a camera or other device capable of detecting markings on the writing surface. For example, the scanner 20a may include a light source and sensor. For example, the scanner 20a may detect black ink on a white background by measuring threshold amounts of light reflected off the writing surface to the sensor. In other examples, the scanner 20a may include an ultraviolet light source to detect fluorescent ink.

The memory storage unit 35a is coupled to the scanner 20a and the optical character recognition engine 25a. The memory storage unit 35a is not particularly limited and may include a non-transitory machine-readable storage medium that may be any electronic, magnetic, optical, or other physical storage device. In the present example, the memory storage unit 30a may store image data received from the optical sensor 20a and the content generated by the optical character recognition engine 25a.

The memory storage unit 35a is not particularly limited. For example, the non-transitory machine-readable storage medium may include random access memory (RAM), electrically-erasable programmable read-only memory (EEPROM), flash memory, a storage drive, an optical disc, and the like. The machine-readable storage medium may also be encoded with executable instructions to carry out a method of converting a physical document with markings into an electronic document.

Furthermore, the memory storage unit 35a may also store an operating system that is executable by a processor to provide general functionality to the apparatus 10a, including functionality to support applications for the optical character recognition engine 25a and the set of instructions to operate the scanner 20a. Examples of operating systems include Windows™, macOS™, iOS™, Android™, Linux™, and Unix™. The memory storage unit 35a may additionally store drivers that are executable to provide specific functionality to the apparatus 10a, such as functionality to communicate with an external device.

In the present example, the optical character recognition engine 25a is to retrieve the image data stored in the memory storage unit 35a. The optical character recognition engine 25a processes the image data to generate content and to store the content back in the memory storage unit 35a.

It is to be appreciated that in this example, the apparatus 10a may not include a communications interface. However, the apparatus 10a includes a memory storage unit 35a which may be used to transfer data periodically. For example, memory storage unit 35a may be a flash memory card that is removeable from the apparatus 10a to be read by an external device, such as a smartphone, a tablet, or a laptop. In a variation of this example, the apparatus 10a may also include an option communications interface for communicating with an external device similar to the apparatus 10 described above.

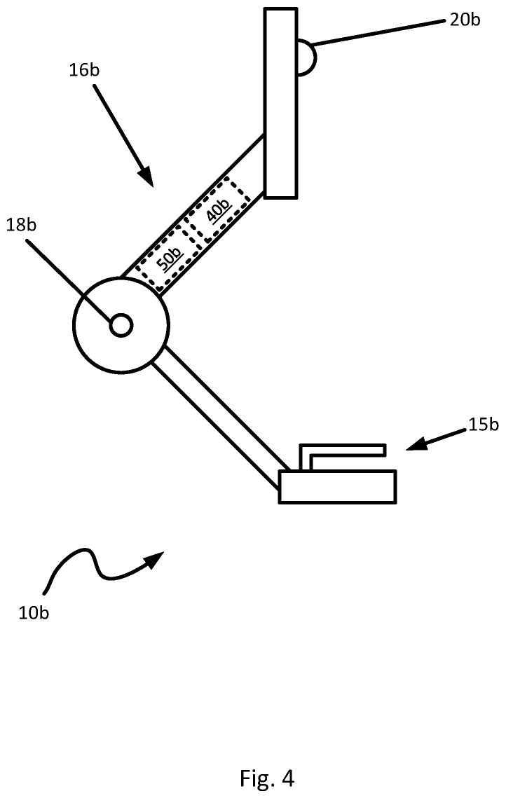

Referring to FIG. 4, another example of an apparatus to convert physical documents with markings into an electronic document is generally shown at 10b. Like components of the apparatus 10b bear like reference to their counterparts in the apparatus 10, except followed by the suffix “b”. In the present example, the apparatus 10b includes a mounting mechanism 15b, a camera 20b, an arm 16b having a hinge 18b, and a processing unit 40b and a power supply 50b disposed and stored within a compartment of the arm 16b or otherwise supported by the arm 16b.

In the present example, the arm 16b is to connect the mounting mechanism 15b to the camera 20b. The arm 16b includes a foldable, rotatable, or otherwise movable portion 18b to allow for the adjustment of the camera 20b relative to the writing surface. Accordingly, a user may use the movable portion 18b to direct the camera 20b to a target portion of the writing surface when the entire writing surface is larger than the field of the camera view. The manner by which the arm 16b folds or moves is not particularly limited. For example, the moveable portion 18b may be a hinge. In other examples, the moveable portion 18b may be made from a pliable material. Furthermore, in some examples, additional moveable portions may ne added to improve articulation.

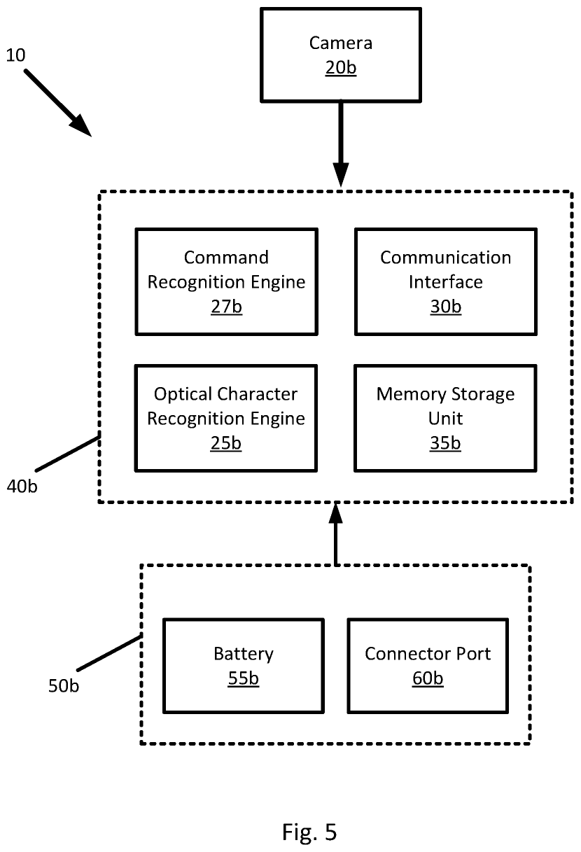

Referring to FIG. 5, a schematic representation of the electronic components of the apparatus 10b is generally shown. In the present example, the camera 20b is to send image data to the processing unit 40b. The power supply 50b is to provide power to the processing unit 40b.

In the present example, the camera 20b is to capture image data which includes the writing surface to which the apparatus 10b is attached. In addition, the camera 20b may capture image data from the environment around or above the writing surface in real time. For example, the camera 20b may also capture movements from a user's hand or pointing device, such as a stylus or a pen. The manner by which the camera 20b captures real time image data is not particularly limited. For example, the camera 20b may periodically take image data after a fixed period of time such as after about each second, about every 0.50 s, about every 0.25 s, or about every 0.10 s. It is to be appreciated that the period is not limited and may be increased to reduce the use of computational resources, or decreased to approach a continuous video feed.

In the present example, the processing unit 40b includes an optical character recognition engine 25b, a command recognition engine 27b, a communications interface 30b, and a memory storage unit 35b. Although the present example shows the optical character recognition engine 25b and the command recognition engine 27b as separate components, in other examples, the optical character recognition engine 25b and the command recognition engine 27b may be part of the same physical component such as a microprocessor configured to carry out multiple functions.

The optical character recognition engine 25b receives image data from the camera 20b in the present example to process and generate content. The manner by which the optical character recognition engine 25b receives the image data is not particularly limited. For example, the optical character recognition engine 25b may be in direct communication with the camera 20b. In such an example, the optical character recognition engine 25b may receive the image data directly from the camera 20b. In other examples, the image data may be retrieved from the memory storage unit 35b. By storing the image data in the memory storage unit 35b, the optical character recognition engine 25b may process the image data at a slower rate than the camera 20b captures the image data. Therefore, a buffer is provided in the event that the optical character recognition engine 25b is unable to process the image data fast enough.

The exact manner by which the optical character recognition engine 25b processes the image data is not limited. For example, the optical character recognition engine 25b may select a database of glyphs stored in the memory storage unit 35b to be used in a pattern recognition process. In other examples, the optical character recognition engine 25b may use artificial intelligence techniques to analyze features in the image data captured by the camera 20b to identify features which may be letters or words. It is to be appreciated by a person of skill with the benefit of this description that by using artificial intelligence techniques, more types of characters maybe recognized by the optical character recognition engine 25b such as cursive handwriting as well as various symbols or words in other languages. Furthermore, the artificial intelligence models used to identify letters or words is not limited. In the present example, the training data for the model may also be stored in the memory storage unit 35b.

The command recognition engine 27b also receives image data from the camera 20b in the present example to process and identify commands. The manner by which the command recognition engine 27b receives the image data is not particularly limited. For example, the command recognition engine 27b may be in direct communication with the camera 20b or the optical character recognition engine 25b. In such an example, the command recognition engine 27b may receive the image data directly from the camera 20b or the optical character recognition engine 25b. In other examples, the image data may be retrieved from the memory storage unit 35b. By retrieving the image data in the memory storage unit 35b, the command recognition engine 27b may process the image data at a slower rate than the camera 20b captures the image data. Therefore, a buffer is provided in the event that the command recognition engine 27b is unable to process the image data fast enough.

The commands recognized by the command recognition engine 27b is not particularly limited. For example, the commands may be in the form of a gesture from a user. The gesture may be a sequence of motions of fingers on the hand of the user, the movement of a pen or stylus, or other motion. Furthermore, the commands are not limited and may include commands to control the apparatus 10b, such as to power on or off the apparatus, to change the settings of the camera 20b to accommodate different lighting situations. In addition, commands may also be used to select where the content generated by the optical character recognition device 25b is to be stored in the memory storage unit 35b, or the external device to which the content generated by the optical character recognition device 25b is to be sent.

The exact manner by which the command recognition engine 27b processes the image data to identify commands is not limited. For example, the command recognition engine 27b may select a database of known gestures stored in the memory storage unit 35b. The gesture may then be identified in the image data and matched with a gesture from the database. In other examples, the command recognition engine 27b may use artificial intelligence techniques to analyze movements in the image data captured by the camera 20b to identify gestures which may be commands.

In the present example, the power supply 50b includes a battery 55b and a connector port 60b. The battery 55b is to provide power to the apparatus 10b for portable use. The battery 55b is not particularly limited and may be any type of battery capable of powering the apparatus 10b. For example, the battery 55b may be a lithium ion battery, a nickel-cadmium battery, or other type of rechargeable battery. In some examples, the battery 55b may be a disposable alkaline battery.

Furthermore, in additional examples, the power supply 50b may be a separate device to be plugged into the processing unit 40b. The power supply 50b may also be divided such that the battery remains in the arm 16b to be recharged with a separate power supply.

The connector port 60b is to receive power to charge the battery 55b. It is to be appreciated that the connector port 60b is optional in examples where the battery 55b is a disposable battery to be replaced when depleted. Furthermore, in some examples where the battery 55b may provide power to for a sufficiently long time, such as the service life of the apparatus 10b, the battery 55b may be non-serviceable and the apparatus 10b may be replaced as a whole upon depletion of the battery 55b.

In the present example, the connector port 60b is to receive a wire connected to a power source. The wire and the connection to the connector port 60b is not limited. For example, the connector port 60b may be a universal serial bus type connector. In other examples, the connector port 60b may be a DC power source. Furthermore, in other examples, the connector port 60b may not be a physical connector to receive a wire. Instead, the connector port 60b may be an inductive charging coil to received power from another inductive charging coil.

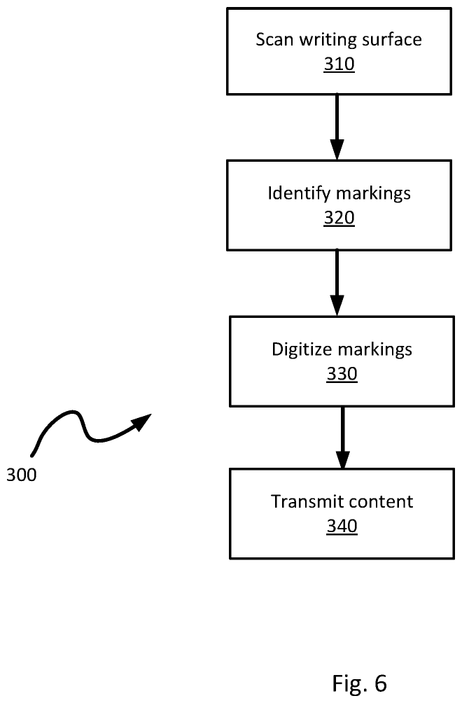

Referring to FIG. 6, a flowchart of a method of converting physical documents with markings into an electronic document is generally shown at 300. In order to assist in the explanation of method 300, it will be assumed that method 300 may be performed with the apparatus 10b. Indeed, the method 300 may be one way in which apparatus 10b may be configured. Furthermore, the following discussion of method 300 may lead to a further understanding of the apparatus 10b and its various components. Furthermore, it is to be emphasized, that method 300 may not be performed in the exact sequence as shown, and various blocks may be performed in parallel rather than in sequence, or in a different sequence altogether.

Block 310 involves scanning a writing surface with the camera 20b to collect image data. The collected image data may be sent directly to either the optical character recognition engine 25b or the command recognition engine 27b. Alternatively, the image data may be stored in the memory storage unit 35b for subsequent processing. In some examples, the image data may be also be stored in the memory storage unit 35b to provide a history of the image data for the purposes of subsequent verification. Furthermore, in some examples, the image data collected may also include a command, such as in the form of a gesture, at or above the writing surface. In some examples, the command may be written onto the writing surface.

In the present example, the camera 20b may be fixed at a predetermined location relative to the writing surface. It is to be appreciated that by fixing the relative position of the camera 20b to the writing surface, forms may be easily scanned and populated in an electronic database if the locations of the fields on a form are known.

In block 320, the optical character recognition engine 25b identifies marking in the image data. The identification of the markings may be carried out in a pre-processing procedure. For example, the markings identified may correspond to a glyph or a character.

Block 330 involves digitizing the markings identified in block 320 to generate content from the image data. The digitization of the markings is not particularly limited and may be carried out by the optical character recognition engine 25b. For example, the optical character recognition engine 25b may use a database of glyphs stored in the memory storage unit 35b to carry out a pattern recognition process. In other examples, the optical character recognition engine 25b may use artificial intelligence techniques to analyze features in the markings to identify letters or words. It is to be appreciated by a person of skill with the benefit of this description that by using artificial intelligence techniques, more types of characters maybe recognized by the optical character recognition engine 25b such as cursive handwriting as well as various symbols or words in other languages.

In some examples, block 330 may not be carried out in the apparatus. Instead, the execution of block 330 may be carried out at an external device such as central server with access to more training data as well as a more robust databased for pattern recognition. Once the markings are digitized, the digitized data is to be returned to the apparatus 10b in the present example. However, in some examples, the external device may carry out block 340 and send the content directly to the final destination, such as another external device, without sending the content back to the apparatus 10b.

Block 340 involves transmitting the content to an external device where the content may be stored. It is to be appreciated that by storing the content externally on an external device, such as a central server, access may be provided to many users for collaborative purposes. Since the content is also digitized and electronic, the content may be subsequently searched to provide more efficiencies if the content is to be subsequently reviewed.

It should be recognized that features and aspects of the various examples provided above may be combined into further examples that also fall within the scope of the present disclosure.

What is claimed is:

1. An apparatus comprising:
a mounting mechanism to engage with a writing surface;
a camera connected to the mounting mechanism, wherein the camera is to scan the writing surface;
an optical character recognition engine to generate content via the digitization of markings on the writing surface; and
a communications interface in communication with the optical character recognition engine to transmit the content to an external device.

2. The apparatus of claim 1, further comprising an arm to connect the mounting mechanism to the camera.

3. The apparatus of claim 2, wherein the arm includes a movable portion to adjust the camera relative to the writing surface.

4. The apparatus of claim 3, wherein the movable portion is a hinge.

5. The apparatus of claim 1, further comprising a battery to provide power for portable use.

6. The apparatus of claim 5, further comprising a connector port to receive power to charge the battery.

7. The apparatus of claim 1, wherein the mounting mechanism is a clip.

8. An apparatus comprising:
a mounting mechanism to engage with a writing surface;
a scanner connected to the mounting mechanism, wherein the scanner is to collect image data of the writing surface;
a memory storage unit in communication with the scanner, the memory storage unit to store the image data; and
an optical character recognition engine to retrieve the image data from the memory storage unit, the optical character recognition to generate content based on the image data, the content to be stored in the memory storage unit.

9. The apparatus of claim 8, further comprising an arm to connect the mounting mechanism to the scanner.

10. The apparatus of claim 9, wherein the memory storage until and the optical character recognition engine is stored in the arm.

11. The apparatus of claim 10, wherein the arm includes a movable portion.

12. The apparatus of claim 11, wherein the movable portion is a hinge.

13. A non-transitory machine-readable storage medium encoded with instructions executable by a processor, the non-transitory machine-readable storage medium comprising:
instructions to scan a writing surface with a camera to collect image data, wherein the camera is mounted at a fixed position relative to the writing surface;
instructions to identify markings in the image data with an optical character recognition engine;
instructions to digitize the markings to generate content associated with the image data; and
instructions to transmit the content to an external device.

14. The non-transitory machine-readable storage medium of claim 13, further comprising instructions to receive a command via the writing surface.

15. The non-transitory machine-readable storage medium of claim 13, further comprising instructions to store a history of image data on a memory storage unit.
